(19) United States
(12) Patent Application Publication
(10) Pub. No.: US 2022/0222283 A1
(43) Pub. Date: Jul. 14, 2022

(54) SELF-LEARNING JOB RECOMMENDATION METHOD AND SYSTEM

(71) Applicant: Nihal Sahul Hameed, San Jose, CA (US)

(72) Inventor: Nihal Sahul Hameed, San Jose, CA (US)

(21) Appl. No.: 17/248,114

(22) Filed: Jan. 11, 2021

(51) Int. Cl. G06F 16/33; G06Q 10/10; G06F 16/903

(52) U.S. Cl. CPC G06F 16/3334; G06F 16/90344; G06Q 10/1053

(57) ABSTRACT

A self-learning method and system for matching job requirements and resumes to provide matching recommendations to job providers and job seekers for efficient hiring and job searching. The job requirements are analyzed and divided as multiple parameters with proficiency level, importance level, and weightage. Each job parameter weightages are adjusted by learning similar parameter details from the resumes applied, interviewed, and offered for previously closed similar job requirements. The new job requirements parameters also learned from the resumes applied, interviewed, and offered for previously closed similar job requirements. The job parameters are matched with resume details and a matching score is calculated based on the level of the match between job and resume considering the job parameters proficiency levels and the learned weightages. The job provider and job seekers are notified with matching resumes and matching jobs with matching scores to improve the efficiency of the hiring and job searching process.

### BACKGROUND OF THE INVENTION

### 1. Field of the Invention

The present invention related to job recruitment tools. In particular, this invention relates to a computer software technique for providing job recommendations to job seekers and candidate recommendations to job providers.

### 2. Description of the Background Art

The job providers and job seekers use internet websites and recruitment-related social media applications to find matching candidates and jobs respectively. These online tools match the jobs and candidates using keywords present in job descriptions and candidate profiles. This leads to poor matching results.

The job providers are recommended with candidates having less relevant skills and candidates who do not meet mandatory job requirements. Similarly, the candidates are recommended with jobs not suiting their career interests. The candidates have to rely on their own keyword-based searching methods to find suitable jobs.

When a large number of applicants apply, the hiring managers are overwhelmed to read every resume to sort list the suitable candidates. Often many of the candidates who applied may not be having relevant experience or required skills. This resume screening process is tedious and time consuming for busy hiring managers.

The US patent application 20120330708 A1 described a method to match the jobs and candidates to provide a ranked list of resumes to job providers and a ranked list of jobs to job seekers. This method requires job providers to construct the job descriptions using the particular software tool described by this patent application. And also the job providers need to qualify each requirement with an importance level. Similarly, the job seekers need to construct the resume using the particular software tool described by this patent application and each skill needs to be rated by the job seeker. The process described in this patent application restricts the job providers and job seekers from providing their own form of job requirements and resumes.

The U.S. Pat. No. 7,720,791 B2 described a technique to match the jobs and job seekers by analyzing the common parameters of the job requirements and job seeker information. This invention used the job seeker and job provider search queries in matching logic. Also, it used the rating feedback for jobs from job seeker to provide shortlisted job recommendations to job seekers. This invention relies on the user feedback to filter the matched jobs and job seekers and if the user does not provide accurate feedback, the matching will reflect this deficiency.

### SUMMARY

A self-learning method and system for providing job and resume matching recommendations with a matching score. The method and system will provide resumes recommendation to job providers based on their job requirements. The method and system will provide job recommendations to job seekers based on their resume details.

The job providers publish their job requirements on the system. The job seekers post their resumes on the system. The method and system maintain all the jobs and resumes data in a database.

When a new job is posted in the system, the job requirements are analyzed and job requirements parameters are identified. The job parameters are qualified with a proficiency level, experience level, and importance level. Based on these levels, an initial weightage score is calculated for job parameters. This initial weightage score is adjusted based on the weightages of similar job parameters in the previously closed similar job requirements. The method and system search the active resumes and finds the resumes that result in high matching scores and recommend those resumes to the job provider. The matching score is calculated based on the match of job parameters and resume parameters and the weightage of the matched job parameters.

When a new resume is posted in the system, the resume parameters are analyzed and identified with a proficiency level and experience level. The method and system search the active jobs and finds the jobs that result in the high matching scores and recommend those jobs to the job seeker.

The method and system have provisions for job providers and job seekers to run a matching logic to view the matching score for any job and resume combination. When job seekers apply to any job, the method and system will notify the job provider along with the matching score of the applied resume for that job.

When a job is successfully closed, the method and system analyzes the applied, interviewed, and offered resumes and adjusts the weightages for the job parameters, and also adds the new job parameters based on the resume parameters. This updated weightage and newly added job parameters are used as learned data to fine-tune the parameters for the new job requirements. The weightages of the new job requirements parameters are adjusted based on the final weightage and additional job parameters of the closed similar jobs.

The method and system continuously learn the weightage for the job parameters and new additional job parameters whenever a job requirement is successfully closed. This learned data is used to improve the job requirements parameters for similar new jobs. This learning mechanism helps to improve the matching of jobs and resume to provide suitable resume recommendation to job providers and suitable job recommendation to job seekers.

### DESCRIPTION OF THE DRAWINGS

FIG. 1 shows a flow diagram of a method of posting a job requirement by a job provider in accordance with an embodiment of the present invention.

FIG. 2 shows a flow diagram of a method of posting a resume by a job seeker in accordance with an embodiment of the present invention.

FIG. 3 shows a flow diagram of a method of updating job record parameters and weightages based on matching previously closed jobs in accordance with an embodiment of the present invention.

FIG. 4 shows a flow diagram of a method of finding matching resumes for newly added job requirements and notifying the job provider and job seekers in accordance with an embodiment of the present invention.

FIG. 5 shows a flow diagram of a method of finding matching jobs for newly added resume and notifying job providers and the job seeker in accordance with an embodiment of the present invention.

FIG. 6 shows a flow diagram of a method of applying to a job by the job seeker in accordance with an embodiment of the present invention.

FIG. 7 shows a flow diagram of a method of closing a job requirement by the job provider in accordance with an embodiment of the present invention.

FIG. 8 shows a flow diagram of a method of updating job record parameters with the final weightages based on applied, interviewed, and offered resumes records in accordance with an embodiment of the present invention.

FIG. 9 shows a logical diagram of a job record in accordance with an embodiment of the present invention.

FIG. 10 shows a logical diagram of a resume record in accordance with an embodiment of the present invention.

The use of the same reference numerals in different drawings indicates the same or similar components.

### DETAILED DESCRIPTION

In the present disclosure, many specific details and examples are described, to provide a thorough understanding of embodiments of the invention of a self-learning job recommendation method and system. Persons with ordinary skill in the field will understand the invention can be used without one or more of these specific details. The well-known details are not described in detail for simplicity.

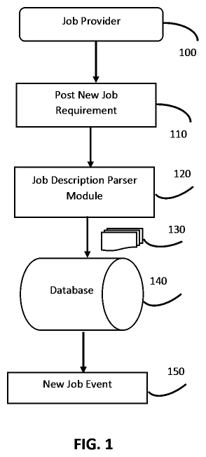

FIG. 1 shows a flow diagram of a method of posting a job requirement in the system by a job provider 100 in accordance with an embodiment of the present invention. In one embodiment, posting a new job requirement 110 may be achieved by a job provider 100 by entering job details in fields of an online form in the system. In another embodiment, posting a new job requirement 110 may be achieved by a job provider 100 by uploading a job description document in a computer-readable format in the system.

Once the job provider 100 submits the job requirement in the system, a job description parser module 120 analyzes details of the job requirements. The job description parser module 120, extracts job parameters and the details about each job parameters from the job description texts. In one embodiment, the job description parser module 120 identifies and categorizes the job parameters into academic parameters, skills parameters, operating condition parameters, and additional parameters. In another embodiment, the job description parser module 120 may classify job parameters in many more categories or lesser categories. In one embodiment, the example academic parameters may be education level, the specialty of the education, and certifications required based on the details provided in the job description. In one embodiment, the example skills parameters may be a programming language, cooking technique, or cold calling based on the details provided in the job description. In one embodiment, the example operating condition parameters may be travel required, working outdoor, or lifting weights based on the details provided in the job description.

The job description parser module 120 identifies the proficiency level for each job parameter. In one embodiment, the example proficiency levels for the parameters may be one of the following levels—expert level, working-level, or beginner level. In another embodiment, the proficiency levels for the parameters may be more finely divided into many more levels. The job description parser module 120 identifies the proficiency level for the job parameter based on the words used in the job description to describe the requirement.

The job description parser module 120 identifies the years or period of experience associated with parameters if mentioned in the job description. Also, the job description parser module 120 identifies the importance level of the job parameters based on the job description details. In one embodiment, the example importance levels may be one of the following—must-have, required, or preferred. In another embodiment, the importance levels may be defined with many more levels. The job description parser module 120 identifies the importance level for the job parameter based on the words used in the job description to describe the requirement.

The job description parser module 120 calculates the initial weightage for each parameter based on the identified proficiency level and importance level of the parameter. In one embodiment, the proficiency levels and importance levels are mapped to numerical values and those numerical values are multiplied to derive the initial weightage as a numerical value. In one embodiment, the example weightage used in the range of 1 to 10, where 1 is the lowest weightage and 10 being the highest weightage. In another embodiment, a different range or different form or weightage system may be used.

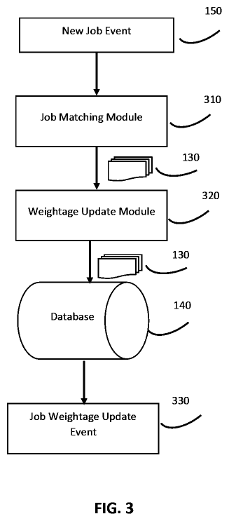

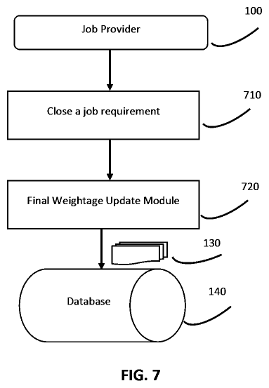

Each job parameter will be associated with three weightages—initial weightage, updated weightage, and final weightage. The job description parser module 120 calculates the initial weightage. The updated weightage is calculated by a weightage update module 320 and the final weightage is calculated by a final weightage update module 720. The weightage update module 320 is explained in detail in the later text when FIG. 3 is described. The final weightage update module 720 is explained in detail in the later text when FIG. 7 is described.

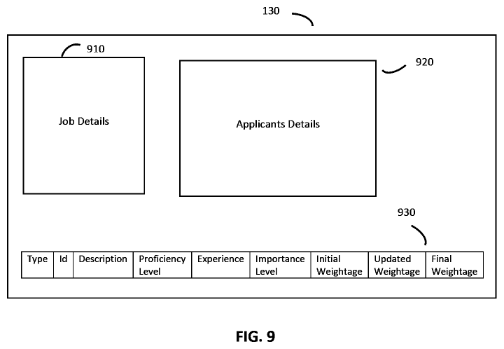

The job description parser module 120 assembles a job record 130 with details of the job description, parameters with proficiency levels, importance levels, and weightages and passes the job record 130 to a database module 140 to store. FIG. 9 shows a logical diagram of the job record 130 in accordance with an embodiment of the present invention.

The database module 140 stores the information related to job details as job records 130 and also stores the information related to resumes in resume record 230. In one embodiment, these records are stored as multi-document text-based records that can be queried using non-SQL query methods. In another embodiment, these records may be stored as database tables with rows and columns that can be queried using traditional database querying languages. The database module 140 may also store additional information provided by the job seeker and job provider in the system which are less relevant to this disclosure. In one embodiment, the example of this additional information may be user profiles, company profiles, notification details, messages exchanged between job provider and job seeker, and much more.

The database module 140 generates events for further processing based on the records created and updated. When the job description parser module 120 creates a new job record 130, the database module 140 generates a new job event 150. The handling of this new job event 150 is explained in the later text while describing the FIG. 3.

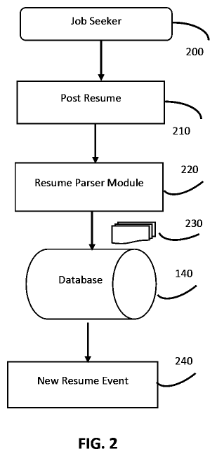

FIG. 2 shows a flow diagram of a method of posting a resume in the system by a job seeker 200 in accordance with an embodiment of the present invention. In one embodiment, posting resume 210 may be achieved by the job seeker 200 by entering resume details in fields of an online form in the system. In another embodiment, posting resume 210 may be achieved by the job seeker 200 by uploading a resume document in a computer-readable format in the system. In one embodiment, if the job seeker 200 provides any cover letter or additional documents along with the resume in the system, the cover letter, and additional documents will also be considered as part of the resume for further processing.

Once a job seeker 200 submits the resume in the system, a resume parser module 220 analyzes the details of the resume. The resume parser module 220, extracts resume parameters and the details about each parameter from the resume texts. In one embodiment, the resume parser module 220 identifies and categorizes the resume parameters into academic parameters, skills parameters, operating condition parameters, and additional parameters. In another embodiment, the resume parser module 220 may classify resume parameters in many more categories or lesser categories. In one embodiment, the example academic parameters may be education level, the specialty of the education, and certifications completed based on the details provided in the resume. In one embodiment, the example skills parameters may be a programming language, cooking methods, or cold calling based on the details provided in the resume. In one embodiment, the example operating condition parameters may be travel preferred, working outdoor, or lifting weights based on the details provided in the resume. In one embodiment, the example additional parameters may be patents filed, awards received or books written based on the details provided in the resume.

The resume parser module 220 identifies the proficiency level for each resume parameter. In one embodiment, the example proficiency levels for the parameters may be one of the following levels—expert level, working-level, or beginner level. In another embodiment, the proficiency levels for the parameters may be more finely divided into many more levels. The resume parser module 220 identifies the proficiency level for the resume parameter based on the words used in the resume to describe the skill or ability.

The resume parser module 220 identifies the years or period of experience associated with parameters if mentioned in the resume.

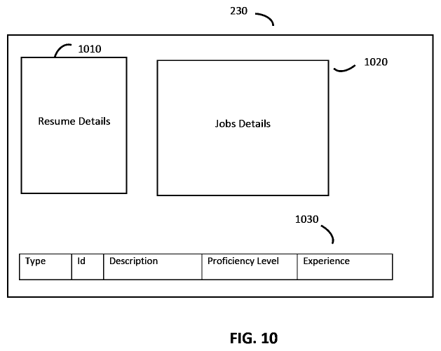

The resume parser module 220 assembles a resume record 230 with details of resume, cover letter if any, resume parameters with proficiency levels and passes the resume record 230 to the database module 140 to store. FIG. 10 shows a logical diagram of a resume record 230 in accordance with an embodiment of the present invention.

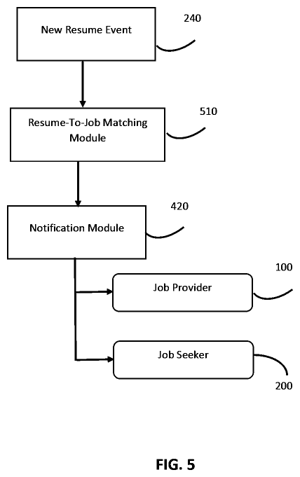

When the resume parser module 220 creates a new resume record 230, the database module 140 generates a new resume event 240. The handling of this new resume event 240 is explained in the later text while describing the FIG. 5.

FIG. 3 shows a flow diagram of a method of updating job record parameters and weightages in the system based on matching previously closed jobs in accordance with an embodiment of the present invention. When a new job record 130 is added, the database module 140 generates a new job event 150 as shown in FIG. 1. This new job event 150 is processed by a job matching module 310 as shown in FIG. 3.

When the new job event 150 is received, the job matching module 310 searches the previously closed job records and finds the job records 130 closest to this newly created job record 130. In one embodiment, the job matching module 310 finds the best matching three closed job records. In other embodiments, the number of matching records found may be more or less than three.

In one embodiment, the job matching module 310 searches the closed job records which are closed after finding the suitable candidates, offers were made and the job was accepted by one of the offered candidates. In one embodiment, the job matching module 310 searches the closed jobs that are relevant to the newly posted job to make the search faster. The relevancy may be decided based on a few factors including but not limited to the industry the job providers belong to and the title of the job.

In one embodiment, the job matching module 310 may consider two jobs records 130 as a match when the below conditions are met:
I. The job title for both the job records need to be closely matched
II. All the must-have parameters in both the job records need to match in proficiency level
III. Most or all of the required parameters in both the job records need to match in proficiency level

IV. Some or many of the preferred parameters in both the job records need to match in proficiency level

V. Years of experience if available need to closely match all the matched parameters in both the job records

In another embodiment, the job matching module 310 may consider two jobs records 130 as a match when one or more parameters present in both the job records with the same proficiency level. In another embodiment, the job matching module 310 may compare the job locations in addition to parameters comparison to decide the jobs records 130 as matching records.

In one embodiment, the job matching module 310 passes the matched job records 130 to a weightage update module 320 for further processing in the system as shown in FIG. 3.

In one embodiment, the weightage update module 320 receives the newly created job record 130 and a number of matched closed job records 130 to update the weightage for the newly created job record 130 based on the closely matched closed job records 130.

In one embodiment, the weightage update module 320 compares the initial weightage of the newly created job record 130 with the final weightage of the closed job records for every matched parameter. If the initial weightage of any parameter in the newly created job record far away from the final weightages of that parameter in closed job records, the weightage update module 320 calculates the adjusted weightage based on the differences in weightages across job records for that parameter and set as updated weightage for that parameter in newly created job record 130.

In one embodiment, the weightage update module 320, finds the mean value of the final weightages for every matched parameter in the closed job records and uses this mean value to find the adjusted weightage for those parameters in the newly created job and sets the newly calculated adjusted weightages as updated weightage in newly created job record 130.

In one embodiment, the weightage update module 320, adds additional parameters to the newly created job record based on the additional parameters and their weightages in matched closed job records. These additional parameters may not be provided by the job providers but may be learned by the final weightage module 720 as described in the later text when FIG. 7 is described in detail.

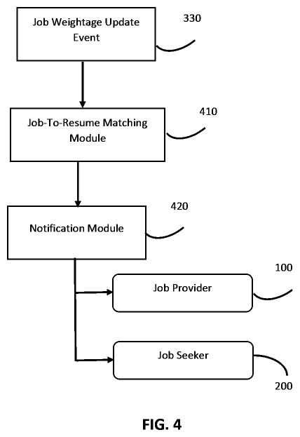

The weightage update module 320 passes the updated newly created job record 130 to the database module 140 to store. When the weightage update module 320 updates the job record 130, the database module 140 generates a job weightage update event 330. This event is handled by a job-to-resume matching module 410 as shown in FIG. 4.

FIG. 4 shows a flow diagram of a method of finding matching resumes for the newly added job requirement and notifying the job provider and the job seekers in the system in accordance with an embodiment of the present invention. The job-to-resume matching module 410 receives and processes the job weightage update event 330.

In one embodiment, when the job weightage update event 330 is received, the job-to-resume matching module 410 searches the active resume records and finds the resume records 230 that are closely matching to this newly created job record 130. In one embodiment, the job-to-resume matching module 410 finds the best matching ten resume records. In other embodiments, the number of matching resume records found may be more or less than ten based on the number of open positions mentioned on the job record 130.

In one embodiment, the job-to-resume matching module 410 searches the active resumes that are relevant to the newly posted job to make the search faster. The relevancy may be decided based on a few factors including but not limited to the job title and location preference.

In one embodiment, the job-to-resume matching module 410 may calculate a matching score in percentages for every active resume record 230 that matches the newly created job record 130. In another embodiment, the job-to-resume matching module 410 may calculate a matching score in other numerical values or ranges or in non-numerical descriptive values. This matching score is calculated based on the factors including but not limited to the below listed:
I. The job title of the job record and job titles present in the experience section and other sections on the resume record.
II. The matching of job parameters and proficiency levels in job record and resume parameters in resume record.
III. The matching of higher weightage parameters results in a higher matching score when comparing to the matching of lower weightage parameters. The updated weightage from the job record is used for this matching score calculation.

In one embodiment, the job-to-resume matching module 410 picks the ‘n’ number of resume records 230 that have the highest matching score for the newly created job record 130 and passes the job record and resume records to a notification module 420 to send notifications to the job provider 100 and job seekers 200 as shown in FIG. 4.

In one embodiment, the notification module 420, receives the job record 130 and matching resume records 230 from the job-to-resume matching module 410 and generates the notifications to the job provider 100 and job seekers 200. The notification module 420 notifies the job provider 100 with the closest matching resumes along with matching scores. The notification module 420 notifies the job seeker 200 with the closest matching job requirements with matching scores. The notification module 420 may support notification settings including but not limited to turn on or off the notification, clear the notification, and minimum matching score for the notifications. The job provider 100 and job seeker 200 may have control to adjust the notification settings provided by the notification module 420.

FIG. 5 shows a flow diagram of a method of finding matching jobs for the newly added resume and notifying job providers and job seeker in the system in accordance with an embodiment of the present invention. The resume-to-job matching module 510 receives and processes the new resume event 240.

In one embodiment, when the new resume event 240 is received, the resume-to-job matching module 510 searches the active job records and finds the job records 130 that are closely matching to this newly created resume record 230. In one embodiment, the resume-to-job matching module 510 finds the best matching ten job records. In other embodiments, the number of matching job records found may be more or less than ten.

In one embodiment, the resume-to-job matching module 510 searches the active job records that are relevant to the newly posted resume to make the search faster. The relevancy may be decided based on a few factors including but not limited to the job title and location preference.

In one embodiment, the resume-to-job matching module 510 may calculate a matching score in percentages for every active job record 130 that matches the newly created resume record 230. In another embodiment, the resume-to-job matching module 510 may calculate a matching score in other numerical values or ranges or in non-numerical descriptive values. This matching score is calculated based on the factors including but not limited to the below listed:
I. The job title of the job record and job titles present in the experience section and other sections on the resume record.
II. The matching of job parameters and proficiency levels in job record and resume parameters in resume record.
III. The matching of higher weightage parameters results in a higher matching score when comparing to the matching of lower weightage parameters. The updated weightage from the job records is used for this matching score calculation.

In one embodiment, the resume-to-job matching module 510 picks the ‘n’ number of job records 130 that have the highest matching score for the newly created resume record 230 and passes the resume record and job records to the notification module 420 to send notifications to the job providers 100 and job seeker 200 as shown in FIG. 5. The notification module 420 sends out a notification to the job seeker with the closest matching job requirements along with the matching score. The notification module 420 also sends out notifications to the job providers about this newly posted resume with its matching score.

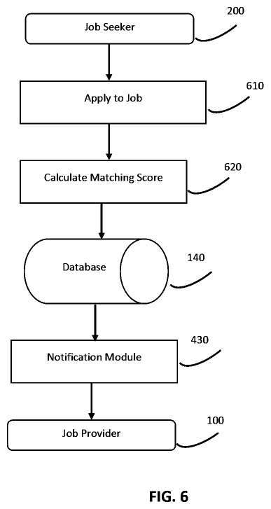

FIG. 6 shows a flow diagram of a method of applying to a job by the job seeker in the system in accordance with an embodiment of the present invention. In one embodiment, when the job seeker 200 applies to any job requirement, a matching score based on the resume record and job record is calculated. This matching score calculation is based on the same logic used in resume-to-job matching module 510.

In one embodiment, when the job seeker 200 applies to any job requirement, the resume record 230 is updated with applied job details, and also the corresponding job record 130 is updated with applied candidate resume details. The updated resume record 230 and job record 130 is pushed to the database 140 to store. The database module 140 will trigger the notification module to send out the notification to the job provider 100 about this new application along with the resume and matching score.

The job records 130 and resume records 230 are updated and stored in database 140 when the interview scheduled for the candidates and offers were made by the job provider. The interview scheduling process and offering process are not described here as they are less relevant to this invention disclosure.

FIG. 7 shows a flow diagram of a method of closing the job requirement in the system by the job provider 100 in accordance with an embodiment of the present invention. In one embodiment, when the job provider 100 closes a job requirement, the final weightage update module 720 calculates the final weightage for each job parameter in job record 130, adds the learned new additional job parameters to the job record 130, and stores the updated job record 130 in the database 140 as shown in FIG. 7.

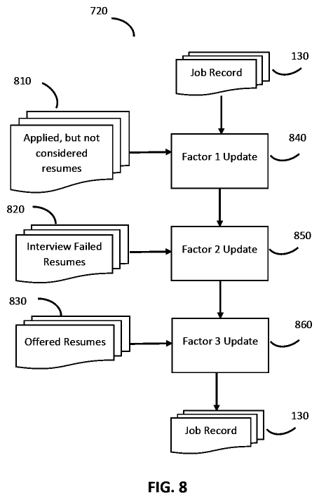

FIG. 8 shows a flow diagram of the final weightage update module 720. In one embodiment, the final weightage update module 720 calculates the final weightage for each job parameter by adjusting the updated weightage available in the job record for that parameter based on the presence or absence of that parameter in the applied, interviewed, and offered resume records. The final weightage update module 720 assigns a higher value for the final weightage for the parameters that are present in applied, interviewed, and offered resume records. The final weightage update module 720 assigns a lower value for the final weightage for the parameters that are not present in the interviewed and offered resume records.

The final weightage update module 720 adds new job parameters to job record 130 based on the resume parameters present in the applied, interviewed, and offered resume records. For example, if the applied, interviewed, and offered resumes have a programming language skill that is not originally present in the job record 130, that skill parameter will be added to job record 130 as an additional parameter. Another example, if the interviewed and offered resume records have a certification course that is not originally present in the job record 130, that certification parameter will be added to job record 130 as an additional parameter. The proficiency level and importance level for the newly added job parameters will be based on the proficiency levels of those parameters in the applied, interviewed, and offered resume records.

In one embodiment, the final weightage update module 720 identifies the resume records 810 that are applied for this job but not selected for interviews. The final weightage update module 720 compares the job parameters and proficiency levels in the closing job record 130 to the resume parameters in the applied resume records 810. For the job parameters that are commonly present in the applied resume records 810 with the closest matching proficiency levels, the factor 1 update 840 is applied with a positive factor. In one embodiment, the commonly present is decided if the parameter is present in more than 50 percent of all the applied resume records 810 with the closest matching proficiency levels. In another embodiment, the commonly present is decided if the parameters are present in all the applied resume records 810 with the closest matching proficiency levels. In one embodiment the factor 1 update 840 calculates the final weightage for the job parameter by increasing the updated weightage by ten percent for the positive update. In another embodiment, the factor 1 update 840 calculates the final weightage for the job parameter by increasing the updated weightage value by one unit for the positive update.

In one embodiment, the parameters that are present in one or more applied resume records 810 but not present in job record 130 may be learned by the final weightage update module 720 and added to the job record 130 as new additional parameters. The proficiency level and importance level for the newly added job parameters will be based on the proficiency levels of those parameters in the applied, interviewed, and offered resume records. In one embodiment, the weightage of these new additional parameters maybe 25% of the maximum weightage value predetermined in the system. In another embodiment, the weightage for these new additional parameters may be more than or less than 25% of the maximum weightage value predetermined in the system.

In one embodiment, the final weightage update module 720 identifies the resume records 820 that are interviewed for this job but not selected for offer. The final weightage update module 720 compares the job parameters and proficiency levels in the closing job record 130 to the resume parameters in the interviewed resume records 820. For the job parameters that are commonly present in the interviewed resume records 820 with the closest matching proficiency levels, the factor 2 update 850 is applied with a positive factor. In one embodiment, the commonly present is decided if the parameter is present in more than 50 percent of all the interviewed resume records 820 with the closest matching proficiency levels. In another embodiment, the commonly present is decided if the parameters are present in all the interviewed resume records 820 with the with the closest matching proficiency levels. For the job parameters that are not present in the interviewed resume records 820, the factor 2 update 850 is applied with a negative factor. In one embodiment the factor 2 update 850 calculates the final weightage for the job parameter by increasing or decreasing the final weightage calculated by factor 1 update 840 by twenty percent for the positive or negative update respectively. In another embodiment, the factor 2 update 850 calculates the final weightage for the job parameter by increasing or decreasing the final weightage value calculated by factor 1 update 840 by two units for the positive or negative update respectively.

In one embodiment, the parameters that are present in one or more interviewed resume records 820 but not present in job record 130 may be learned by the final weightage update module 720 and added to the job record 130 as new additional parameters. In one embodiment, the weightage of these new additional parameters maybe 50% of the maximum weightage value predetermined in the system. In another embodiment, the weightage for these new additional parameters may be more than or less than 50% of the maximum weightage value predetermined in the system.

In one embodiment, the final weightage update module 720 identifies the resume records 830 that are offered for this job. The final weightage update module 720 compares the job parameters and proficiency levels in the closing job record 130 to the resume parameters in the offered resume records 830. For the job parameters that are commonly present in the offered resume records 830 with the closest matching proficiency levels, the factor 3 update 860 is applied with a positive factor. In one embodiment, the commonly present is decided if the parameter is present in more than 50 percent of all the offered resume records 830 with the closest matching proficiency levels. In another embodiment, the commonly present is decided if the parameters are present in all the offered resume records 830 with the with the closest matching proficiency levels. For the job parameters that are not present in the offered resume records 830, the factor 3 update 860 is applied with a negative factor. In one embodiment the factor 3 update 860 calculates the final weightage for the job parameter by increasing or decreasing the final weightage calculated by factor 2 update by thirty percent for the positive or negative update respectively. In another embodiment, the factor 3 update 860 calculates the final weightage for the job parameter by increasing or decreasing the final weightage value calculated by factor 2 update 850 by three units for the positive or negative update respectively.

In one embodiment, the parameters that are present in one or more offered resume records 830 but not present in job records may be learned by the final weightage update module 720 and added to the job record as new additional parameters. In one embodiment, the weightage of these new additional parameters maybe 75% of the maximum weightage value predetermined in the system. In another embodiment, the weightage for these new additional parameters may be more than or less than 75% of the maximum weightage value predetermined in the system.

In another embodiment, the final weightage module 720 may use a combination of factor 1 update 840, factor 2 update 850, and factor 3 update 860 by omitting one or more factor updates.

FIG. 9 shows a logical diagram of the job record 130 in accordance with an embodiment of the present invention. In one embodiment, the job record 130 has multiple data records including but not limited to job details record 910, applicant details record 920 and the job parameters list 930. The job details record 910 has the details provided by job provider 100 about the job including the job title, description, number of positions, and other parameters. The applicant details record 920 has the reference to the list of applicant resumes that are applied to this job. The application details record 920 maintains with resume matching score, application status as applied, interviewed, offered, or offer accepted and relevant parameters including the applying time. The job parameters list 930 has all the job parameters with parameter details. The parameters details include but not limited to parameters identifier, parameter type, parameter description, proficiency level, importance level, initial weightage, updated weightage, and final weightage.

FIG. 10 shows a logical diagram of the resume record 230 in accordance with an embodiment of the present invention. In one embodiment, the resume record 230 has multiple data records including but not limited to resume details record 1010, job details record 1020, and the resume parameters list 1030. The resume details record 1010 has the details provided by job seeker 200 about the resume including the cover letter and other preference parameters if any. The job details record 1020 has the reference to the list of job records that are applied with this resume. The job details record 1020 maintains with job matching score, application status as applied, interviewed, offered, or offer accepted and relevant parameters including the applying time. The resume parameters list 1030 has all the resume parameters with parameter details. The parameters details include but not limited to parameters identifier, parameter type, parameter description, proficiency level, and experience.

In one embodiment, the job provider 100 can view the matching score in the system for any selected active resume for their open job requirements using the view tools supported by the resume-to-job matching module 510 logic. Similarly, the job seekers 200 can view the matching score in the system for any selected active job for their resume using the view tools supported by the resume-to-job matching module 510 logic.

The method and system disclosed here provide efficient recommendations for job providers and job seekers by learning the job parameters weightages and additional job requirements from the successfully closed similar jobs.

A self-learning job recommendation method and system are disclosed. While one or more embodiments of the present invention have been disclosed, these disclosed embodiments are for example illustration purposed and not limiting. Any person with ordinary skill in the field can find many additional embodiments based on this disclosure.

What is claimed is:

1. A method for matching job requirements and resumes comprising the steps of:
calculating a weightage for job requirements parameters;
updating said weightage based on matching parameters on resumes that were applied to previously closed jobs that are similar to said job;
calculating a matching score for any resume and said job using said updated weightage.

2. The method of claim 1 wherein updating said weightage is done based on said matching parameters on said applied resumes that resulted in interviews for said previously closed jobs.

3. The method of claim 1 wherein updating said weightage is done based on said matching parameters on said applied resumes that resulted in offers for said previously closed jobs.

4. The method of claim 1 wherein said matching score is shared with job providers and job seekers.

5. A method for identifying job requirements parameters comprising the steps of:
extracting job requirements parameters from job details;
adding new additional job requirements parameters found from resumes that were applied to previously closed jobs that are similar to said job;
calculating a matching score for any resume and said job using said newly added job requirements parameters.

6. The method of claim 5 wherein adding new additional job requirements parameters are found from said applied resumes that resulted in interviews for said previously closed jobs.

7. The method of claim 5 wherein adding new additional job requirements parameters are found from said applied resumes that resulted in offers for said previously closed jobs.

8. The method of claim 5 wherein said matching score is shared with job providers and job seekers.

9. A system for matching job requirements and resumes comprising:
at least one processor to execute computer-readable code;
at least one memory;
a database to store job and resume data;
a computer-readable code to calculate weightage for job requirements parameters;
a computer-readable code to update said weightage based on matching parameters on resumes that were applied to previously closed jobs that are similar to said job;
a computer-readable code to calculate a matching score for any resume and said job using said updated weightage.

10. The system of claim 9 wherein a computer-readable code to update said weightage based on said matching parameters on said applied resumes that resulted in interviews for said previously closed jobs.

11. The system of claim 9 wherein a computer-readable code to update said weightage based on said matching parameters on said applied resumes that resulted in offers for said previously closed jobs.

12. The system of claim 9 wherein a compute readable code to share said matching score with job providers and job seekers.

13. A system for identifying job requirements parameters comprising:
at least one processor to execute computer-readable code;
at least one memory;
a database to store job and resume data;
a computer-readable code to extract job requirements parameters from job details;
a computer-readable code to add new additional job requirements parameters found from resumes that were applied to previously closed jobs that are similar to said job;
a computer-readable code to calculate a matching score for any resume and said job using said newly added job requirements parameters.

14. The system of claim 13 wherein a computer-readable code to add new additional job requirements parameters found from said applied resumes that resulted in interviews for said previously closed jobs.

15. The system of claim 13 wherein a computer-readable code to add new additional job requirements parameters found from said applied resumes that resulted in offers for said previously closed jobs.

16. The system of claim 13 wherein a compute readable code to share said matching score with job providers and job seekers.
